(19) United States
(12) Patent Application Publication
(10) Pub. No.: US 2014/0153240 A1
(43) Pub. Date: Jun. 5, 2014

(54) ARRANGEMENT FOR EMITTING LIGHT

(71) Applicants: Stephan Ebner, Dornbirn (AT); Patrik Gassner, St. Gerold (AT)

(72) Inventors: Stephan Ebner, Dornbirn (AT); Patrik Gassner, St. Gerold (AT)

(73) Assignee: ZUMTOBEL LIGHTING GMBH, Dornbirn (AT)

(21) Appl. No.: 14/233,045

(22) PCT Filed: Jul. 18, 2012
(86) PCT No.: PCT/EP2012/064049

§ 371 Date: Jan. 16, 2014

(30) Foreign Application Priority Data
Jul. 19, 2011 (DE) 10 2011 079 393.3

(51) Int. Cl. F21V 5/00

(52) U.S. Cl. CPC F21V 5/008; F21V 5/007
USPC 362/237; 362/268

(57) ABSTRACT

An arrangement for emitting light having at least one LED-light source and at least one first lens arranged in front of the LED light source in the light-emitting direction, wherein a second lens is arranged in front of the first lens in the light emitting direction for influencing the light emitted from the first lens.

The present invention relates to an arrangement for emitting light comprising at least one LED light source and at least one first lens arranged in front of the LED light source in the light emission direction.

In the case of elongate luminaires or arrangements for emitting light used in the commercial sector, for example, heretofore fluorescent lamps have often been used as the light source. The advancing development of LEDs now has the consequence more and more that e.g. fluorescent lamps are being replaced by corresponding LEDs. This arises firstly from the fact that LED light sources have considerable advantages regarding lifetime and energy efficiency in comparison with conventional illuminants. Secondly, the light intensities achievable with the aid of LEDs have in the meantime become high enough, such that LED light sources can readily replace traditional light sources such as fluorescent lamps, for example.

In order, then, to achieve a desired emission characteristic of the entire arrangement, provision is made, for example, for lenses to be assigned to the LED light sources, said lenses being arranged in front of the LED light sources in the emission direction. A plurality of such lenses are joined together in this case to form an elongate optical element, wherein preferably exactly one lens of the optical element is assigned to each LED light source.

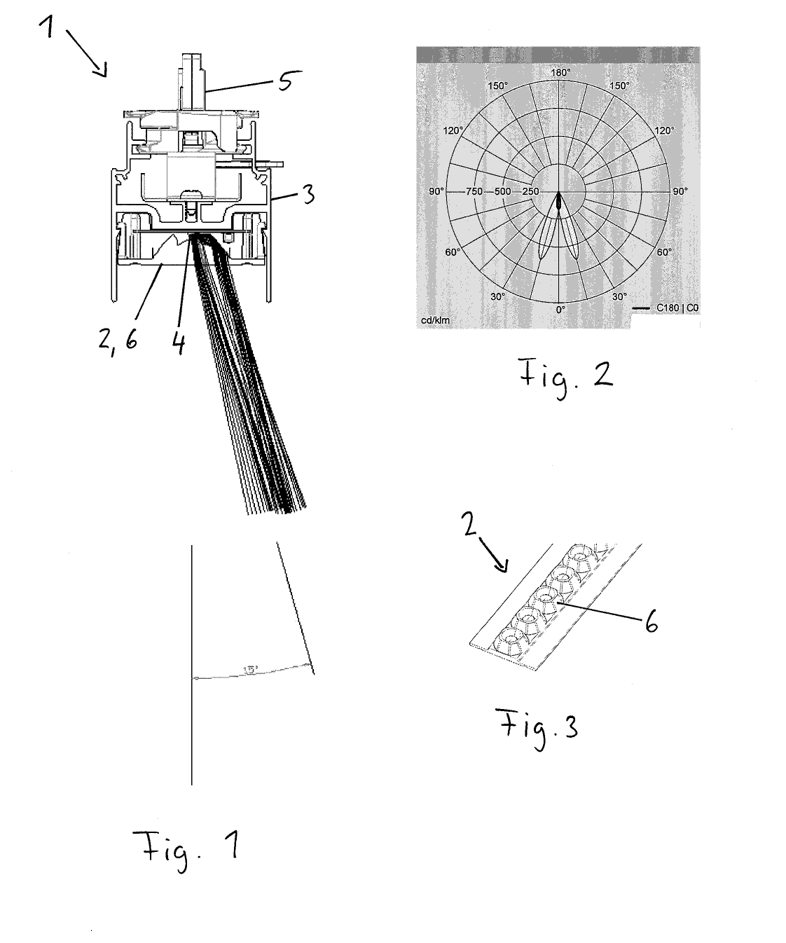

FIG. 1 shows such an arrangement for emitting light 1 having a housing 3 having a light exit opening, wherein the LED light sources 4 are arranged in the housing 3 and the lenses 6 joined together to form the optical element 2 close the housing 3 in the light emission direction. FIG. 3 shows an optical element 2 consisting of a plurality of lenses 6. Such optical elements 2 are in this case usually produced by the injection-molding method.

The light intensity distribution curve of the lenses 6 shown in FIG. 3 or of the optical element 2 and accordingly also of the arrangement for emitting light 1 is evident from FIG. 2, wherein the curve illustrated therein corresponds to the values in the C0/C180 plane, that is to say in the transverse direction with respect to the optical element 2 shown in FIG. 3 or the arrangement for emitting light 1. In this case, the light intensity distribution curve shown in FIG. 2 has two mutually separate wings which have in each case a peak region at 15° and flank regions adjacent thereto on both sides, in which flank regions the light intensity falls to a significantly lower value than in the peak region, wherein one of the flanks falls toward the angular range around 0°. In this case, the angle between the two peak regions of the wings corresponds to the aperture or emission angle of the light emitted from the first lens. Accordingly, here the aperture or emission angle has a value of 30°.

Such a light intensity distribution is advantageous e.g. when a corresponding arrangement for emitting light 1 is intended to be arranged along an aisle having shelves in each case on the right and left, which shelves are intended to be correspondingly illuminated by the arrangement for emitting light 1.

The half aperture or emission angle of 15° evident from FIG. 2 is additionally also depicted again in FIG. 1. This aperture or emission angle arises as a result of the configuration of the lenses 6, for which reason this aperture or emission angle can be varied by a corresponding change in the design of the lenses 6 if a different aperture or emission angle of the arrangement for emitting light 1 is desired.

In this case, however, there is the problem, then, that such a change in the emission or aperture angle necessitates exchanging the entire optical element, which causes correspondingly high costs. In addition, considerable costs also arise as a result of the production of further optical elements by the injection-molding method, since dedicated tools or molds have to be produced for each alternative embodiment, which leads to high costs.

Accordingly, the present invention is based on the object of further developing the arrangement for emitting light outlined above in such a way that the aperture or emission angle of the arrangement for emitting light can be varied, without the lenses or the optical element having to be exchanged.

The object is achieved by means of an arrangement for emitting light as claimed in claim 1. The dependent claims relate to advantageous developments of the invention.

The invention proposes an arrangement for emitting light, comprising at least one LED light source and at least one first lens arranged in front of the LED light source in the light emission direction, wherein a second lens for influencing the light emitted from the first lens is arranged in front of the first lens in the light emission direction.

The light intensity distribution curve of the light emitted from the first lens in the C0/C180 plane can have in this case two substantially symmetrical, mutually separate wings which lie in each case substantially in an angular range of 0° to 90° relative to an axis parallel to the light emission direction through the light centroid of the first lens and have in each case a peak region and flank regions adjacent thereto on both sides, on which flank regions the light intensity falls to a significantly lower value than in the peak region, wherein the peak region lies at angles of greater than 0° and one of the flanks falls toward the angular range around 0°, wherein the angle between the two peak regions of the wings corresponds to the aperture or emission angle of the light emitted from the first lens.

Furthermore, provision can also be made for the aperture or emission angle of the light emitted from the first lens to be greater than 0°.

In addition, the second lens can be designed and arranged in front of the first lens in such a way that the aperture or emission angle of the light emitted from the first lens is reduced by the second lens.

Alternatively, the second lens could also be designed and arranged in front of the first lens in such a way that the aperture or emission angle of the light emitted from the first lens is increased by the second lens.

The second lens therefore now makes it possible that the aperture or emission angle of the light emission of the entire arrangement for emitting light can be varied, without the first lens having to be exchanged, the light emission in the C90/C270 plane being influenced in particular by the first lens.

As already explained above, here as well provision can be made for the arrangement for emitting light to have a plurality of LED light sources and a plurality of first lenses, wherein the first lenses are joined together to form an optical element. In addition, provision can also be made for in each case exactly one first lens of the optical element to be assigned to each LED light source. Furthermore, provision can likewise be made for the arrangement for emitting light to have a housing having a light exit opening, wherein the at least one LED light source is arranged in the housing and the at least one first lens closes the housing in the light emission direction.

Furthermore, provision can be made for second lenses to be assigned only to a portion of the first lenses.

The invention will be explained in greater detail below on the basis of exemplary embodiments and the accompanying drawings, in which:

FIG. 1 shows an arrangement for emitting light comprising an optical element having a plurality of first lenses;

FIG. 2 shows the light intensity distribution curve of the arrangement for emitting light shown in FIG. 1 or of the optical element in the transverse direction;

FIG. 3 shows an illustration of a plurality of first lenses joined together to form an optical element;

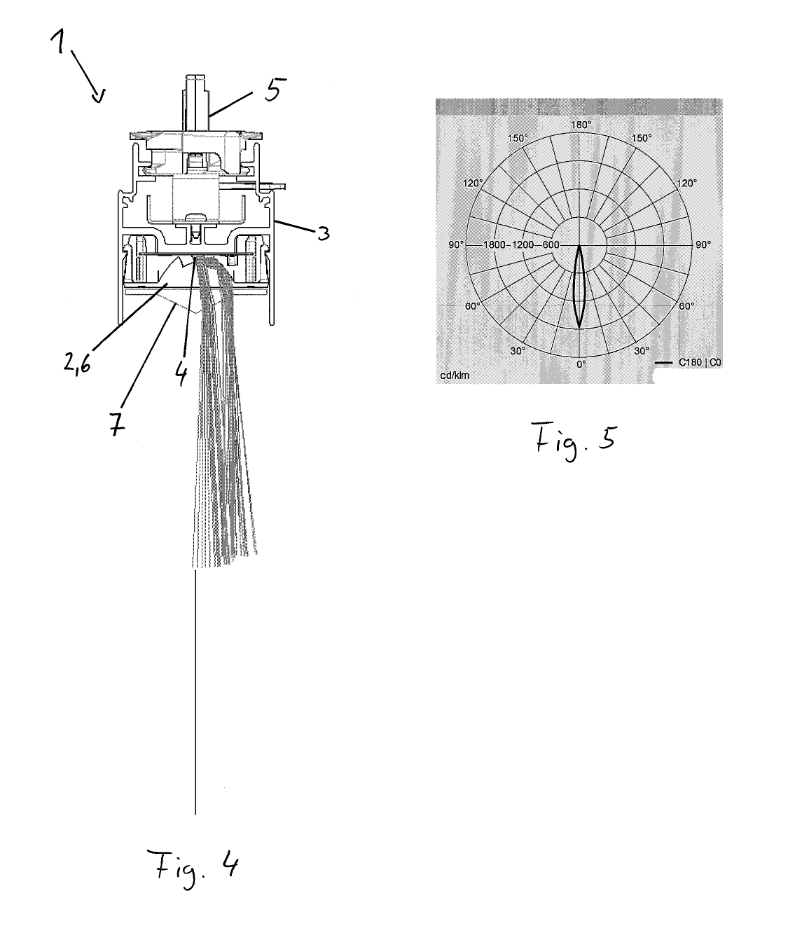

FIG. 4 shows an arrangement for emitting light according to the invention in accordance with a first embodiment;

FIG. 5 shows the light intensity distribution curve of the arrangement for emitting light shown in FIG. 4 in the transverse direction;

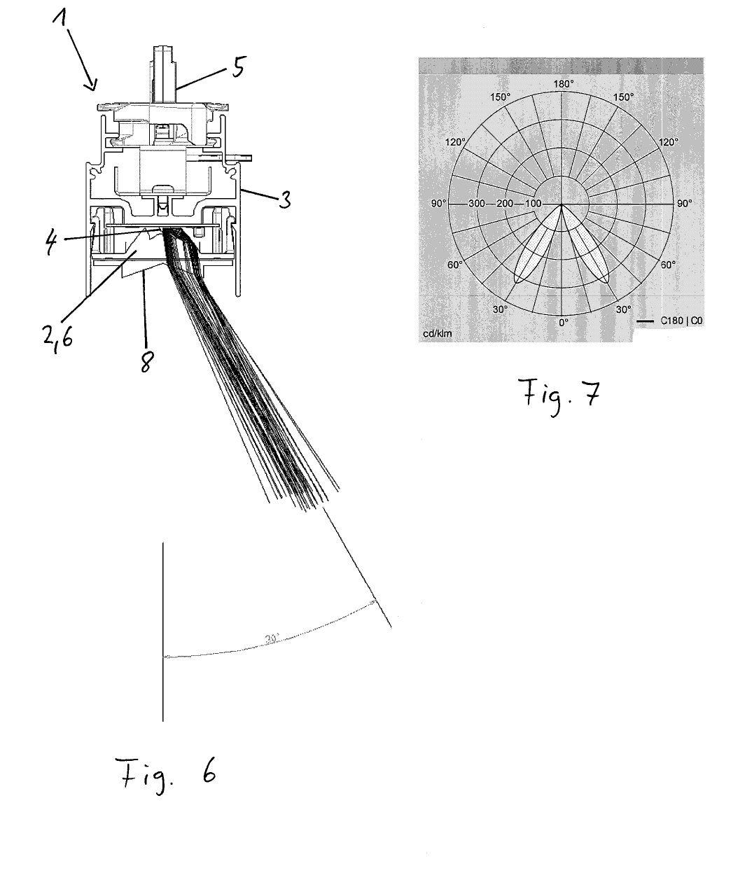

FIG. 6 shows an arrangement for emitting light according to the invention in accordance with a second embodiment;

FIG. 7 shows the light intensity distribution curve of the arrangement for emitting light shown in FIG. 6 in the transverse direction.

FIG. 1 shows, as already explained, an arrangement for emitting light 1 known from the prior art.

The arrangement for emitting light 1 has a housing 3 having a light exit opening, wherein LED light sources 4 are arranged in the housing 3 and the light exit opening is closed by an optical element 2. In this case, the optical element 2 consists of a plurality of first lenses 6 arranged in front of the LED light sources 4 in the light emission direction. Such an optical element 2 composed of a plurality of lenses 6 is shown by way of example in FIG. 3.

FIG. 2 shows the emission characteristic or light intensity distribution curve of such first lenses 6 or of the optical element 2 and thus of the arrangement for emitting light 1 in the C0/C180 plane and thus in the transverse direction with respect to the arrangement for emitting light 1 or the optical element 2. This light intensity distribution is suitable, for example, for stores selling merchandise in which, along aisles, on the left and right in each case shelves are arranged relatively near the aisles, which are intended particularly to be illuminated by corresponding arrangements for emitting light 1.

Furthermore, in the arrangement for emitting light 1, a device 5 is also provided at the top side of the housing, which device enables the arrangement for emitting light 1 to be mechanically fixed to a supporting rail and furthermore makes contact with lines running within the supporting rail.

The invention then provides for a second lens 7, 8 for influencing the light emitted from the first lens to be arranged in front of the first lens 6 in the light emission direction. In this respect, FIGS. 4 and 6 illustrate two exemplary embodiments according to the invention, wherein the arrangements for emitting light 1 shown in FIGS. 4 and 6 otherwise each have the same components as the arrangement for emitting light 1 in FIG. 1. FIG. 4 shows here a corresponding configuration variant in which a second lens 7 is designed and arranged in front of the first lens 6 in such a way that the aperture or emission angle of the light emitted from the first lens 6 is reduced or decreased by the second lens 7, the aperture or emission angle tending toward 0° in the case of the variant shown in FIG. 4.

The corresponding light intensity distribution curve or light emission characteristic with respect to the arrangement for emitting light 1 shown in FIG. 4 is shown in FIG. 5. The latter, in contrast to the light intensity distribution curve shown in FIG. 2, which reveals two peak regions at 15° in each case, reveals only one peak region at 0°, thus resulting in an aperture or emission angle of 0°. As a result, the arrangement for emitting light 1 from FIG. 4 is suitable, for example, for illuminating aisles in stores selling merchandise where no shelves are arranged on the left and right.

As can be gathered from FIG. 4, the second lens 7 comprises a triangle tapering toward the center, wherein the triangle is arranged at that side of the second lens 7 which faces away from the first lens 6, and the vertex of the triangle points away from the first lens 6 or the LED light source 4. This triangular shape refracts the light emitted from the first lens 6 with an aperture or emission angle of 15°, or deflects it, in such a way that the aperture angle or emission angle then substantially has a value of 0°.

As already explained, such a configuration is desirable, for example, when shelves are no longer arranged laterally along an aisle and, accordingly, only the aisle is intended to be illuminated, or when high shelves are to be illuminated. In this case, however, it is now no longer necessary that the entire optical element has to be exchanged in an arrangement for emitting light. Rather, it is readily possible for an arrangement for emitting light to be installed with a corresponding optical element and for second lenses then subsequently to be assigned to the arrangement for emitting light in accordance with the local conditions. In this regard, it is conceivable, for example, that in the event of a reconfiguration of aisles in stores where previously normal shelves were arranged laterally along the aisle and, accordingly, for example arrangements for emitting light 1 as shown in FIG. 1 were used, after a reconfiguration that involves removing the shelves or arranging correspondingly high shelves, it is not necessary to exchange the entire arrangement for emitting light or the optical element 2, rather it is merely necessary to assign second lenses 7 to the arrangement for emitting light 1.

The exemplary embodiment shown in FIG. 4 shows a variant in which the aperture or emission angle is substantially 0°. However, it would also be conceivable for the aperture or emission angle not to be reduced to such a great extent, or to be reduced to an even greater extent.

In contrast to the exemplary embodiment shown in FIG. 4, in which the aperture or emission angle is reduced by the second lens 7, in the case of the exemplary embodiment shown in FIG. 6, a second lens 8 is provided in front of the first lens 6 and increases the aperture or emission angle of the light emitted from the first lens. As can be gathered from FIGS. 6 and 7, the second lens 8 in this case is configured in such a way that the half aperture or emission angle has a value of approximately 30°. The light intensity distribution curve of the arrangement for emitting light 1 shown in FIG. 6 can in turn be gathered here from FIG. 7, wherein, in comparison with the light intensity distribution curve in FIG. 2, it can be discerned that the two peak regions are now situated at 30° and the aperture or emission angle thus has a value of 60°. Accordingly, this arrangement for emitting light 1 has a light intensity distribution which, like the light intensity distribution of the arrangement for emitting light 1 shown in FIG. 1, exhibits two substantially symmetrical wings.

As can be gathered from FIG. 6, the second lens 8 has a wide open V-shape at the side facing away from the first lens 6, wherein the vertex of the V-shape points in the direction of the first lens 6. This shape, substantially forming the counterpart to the shape of the second lens 7 from FIG. 4, refracts the light emitted from the first lens 6, or deflects it, in such a way that the half aperture or emission angle predefined by the first lens is increased from 15° to 30°.

The increase in the aperture or emission angle then makes it possible that an arrangement for emitting light according to the invention can for example also be used for illuminating shelves in wider aisles or with lower suspended heights of the ceilings in sales areas. In this regard, it would furthermore also be conceivable that for example in the event of a reconfiguration of a sales area where an aisle is widened or the suspended height of the ceiling is made lower, the previously used arrangement for emitting light 1, as shown in FIG. 1, for example, is adapted by the simple fitting of the second lens 8 and it is thus ensured that the shelves are correspondingly well illuminated after the reconfiguration of the sales areas as well.

As already in the case of the embodiment shown in FIG. 4, in the case of the embodiment shown in FIG. 6, too, it should be mentioned that the second lens 8 can also be configured such that the aperture or emission angle is increased to a greater or lesser extent.

Overall, it should be noted with regard to the present invention that as a result thereof an aperture or emission angle predefined by a first optical unit can be varied by a second optical unit arranged in front of the first optical unit, wherein in the C90/C270 plane an influence (suppression of glare, reduction of luminance, compliance with UGR) is effected in particular by the first lens and the second lens hardly has any influence thereon.

1. An arrangement for emitting light comprising at least one LED light source and at least one first lens arranged in front of the LED light source in the light emission direction, wherein a second lens for influencing the light emitted from the first lens is arranged in front of the first lens in the light emission direction.

2. The arrangement for emitting light as claimed in claim 1, wherein the light intensity distribution curve of the light emitted from the first lens in the C0/C180 plane has two substantially symmetrical, mutually separate wings which lie in each case substantially in an angular range of 0° to 90° relative to an axis parallel to the light emission direction through the light centroid of the first lens and have in each case a peak region and flank regions adjacent thereto on both sides, on which flank regions the light intensity falls to a significantly lower value than in the peak region, wherein the peak region lies at angles of greater than 0° and one of the flanks falls toward the angular range around 0°, wherein the angle between the two peak regions of the wings corresponds to the aperture or emission angle of the light emitted from the first lens.

3. The arrangement for emitting light as claimed in claim 1, wherein the aperture or emission angle of the light emitted from the first lens is greater than 0°.

4. The arrangement for emitting light as claimed in claim 1, wherein the second lens is designed and arranged in front of the first lens in such a way that the aperture or emission angle of the light emitted from the first lens is reduced by the second lens.

5. The arrangement for emitting light as claimed in claim 1, wherein the second lens is designed and arranged in front of the first lens in such a way that the aperture or emission angle of the light emitted from the first lens is increased by the second lens.

6. The arrangement for emitting light as claimed in claim 1, wherein the arrangement for emitting light has a plurality of LED light sources and a plurality of first lenses wherein the first lenses are joined together to form an optical element.

7. The arrangement for emitting light as claimed in claim 6, wherein in each case exactly one first lens of the optical element is assigned to each LED light source.

8. The arrangement for emitting light as claimed in claim 6, wherein second lenses are assigned only to a portion of the first lenses.

9. The arrangement for emitting light as claimed in claim 1, wherein the arrangement for emitting light has a housing having a light exit opening, wherein the at least one LED light source is arranged in the housing and the at least one first lens closes the housing in the light emission direction.
